(19) United States
(12) Patent Application Publication
(10) Pub. No.: US 2014/0093041 A1
(43) Pub. Date: Apr. 3, 2014

(54) DETECTING APPARATUS, RADIATION DETECTING SYSTEM, AND METHOD OF MANUFACTURING DETECTING APPARATUS

(71) Applicant: CANON KABUSHIKI KAISHA, Tokyo (JP)

(72) Inventors: Taiki Takei, Okegawa-shi (JP); Masato Inoue, Kumagaya-shi (JP); Shinichi Takeda, Honjo-shi (JP); Satoru Sawada, Fujioka-shi (JP); Takamasa Ishii, Honjo-shi (JP); Kota Nishibe, Honjo-shi (JP)

(73) Assignee: CANON KABUSHIKI KAISHA, Tokyo (JP)

(21) Appl. No.: 14/040,422

(22) Filed: Sep. 27, 2013

(30) Foreign Application Priority Data
Sep. 28, 2012 (JP) 2012-218072

(51) Int. Cl. G01T 1/20

(52) U.S. Cl. CPC G01T 1/20
USPC 378/62; 250/361 R; 378/98; 427/70

(57) ABSTRACT

A sensor panel provided with a photoelectric conversion element that detects entering light, a columnar-structure scintillator layer arranged on the sensor panel, a light reflection layer formed on the columnar-structure scintillator layer, and a resin layer including a particulate scintillator formed between the columnar-structure scintillator layer and the light reflection layer are included in a detecting apparatus, and the resin layer includes a particulate scintillator.

### BACKGROUND OF THE INVENTION

1. Field of the Invention

The present invention relates to a detecting apparatus, a radiation detecting system, and a method of manufacturing a detecting apparatus.

2. Description of the Related Art

Radiation detecting apparatuses including a sensor panel provided with an optical detection sensor that detects light and a scintillator layer disposed on the sensor panel and converting radiation into light have been commercialized. As a scintillator used in the radiation detecting apparatus, an alkali halide material represented by a material in which CsI doped with Tl is mainly used. The scintillator made of an alkali halide material formed by a vapor deposition method presents a columnar crystal structure, and is therefore favorable in terms of spatial resolution and sharpness.

US Patent Application Publication No. 2007/0257198 discloses a detecting apparatus having the following configuration. In a case of a type formed by a vapor deposition method in which an alkali halide scintillator material is directly formed on a sensor panel, a light reflection layer is typically provided on a scintillator layer for improvement of characteristics. The light reflection layer is provided to reflect light toward the sensor panel, the light being emitted on the scintillator layer and having been emitted toward a side opposite to the sensor panel. In addition, a resin layer is provided between the scintillator layer and the light reflection layer. Usually, this resin layer needs to have a certain thickness to protect a surface (upper surface) of the scintillator layer from impact from an outside.

However, since the adhesive layer has the certain thickness or more, there is a problem that a part of light emission from the scintillator having a columnar crystal structure into a direction of the light reflection layer and reflected light by the light reflection layer are absorbed in the adhesive layer, and the quantity of light that reaches the sensor panel is decreased.

### SUMMARY OF THE INVENTION

The present invention has been made in view of the foregoing, and an objective is to provide a method of manufacturing a detecting apparatus and a detecting apparatus that suppresses a decrease in quantity of light that reaches a sensor panel even if a resin layer that sticks a scintillator layer and a light reflection layer is provided.

A method of manufacturing a detecting apparatus according to the present invention includes the processes of: preparing a sensor panel provided with a photoelectric conversion element configured to detect entering light; forming a columnar-structure scintillator layer on the sensor panel; forming a resin layer including a particulate scintillator on the columnar-structure scintillator layer, and forming a light reflection layer on the resin layer.

A detecting apparatus according to the present invention includes: a sensor panel provided with a photoelectric conversion element configured to detect entering light; a columnar-structure scintillator layer arranged on the sensor panel; a light reflection layer formed on the columnar-structure scintillator layer; and a resin layer formed between the columnar-structure scintillator layer and the light reflection layer, and the resin layer includes a particulate scintillator.

According to the present invention, a decrease in quantity of light that reaches the sensor panel can be suppressed even if the resin layer that sticks the scintillator layer and the light reflection layer is provided.

### BRIEF DESCRIPTION OF THE DRAWINGS

FIG. 1 is a schematic cross sectional view illustrating a structure of a radiation detecting apparatus according to a first embodiment;

FIGS. 2A and 2B are schematic cross sectional views illustrating examples of a sensor panel of the radiation detecting apparatus according to the first embodiment;

FIG. 3 is a schematic plan view illustrating a structure of the radiation detecting apparatus according to the first embodiment;

FIG. 4 is a schematic cross sectional view showing an enlarged interface between a scintillator layer and a resin layer in a method of manufacturing a radiation detecting apparatus according to a second embodiment; and

FIG. 5 is a schematic diagram for describing a radiation detecting system according to a third embodiment.

### DESCRIPTION OF THE EMBODIMENTS

Hereinafter, embodiments to which the present invention is applied will be described in detail with reference to the drawings.

### First Embodiment

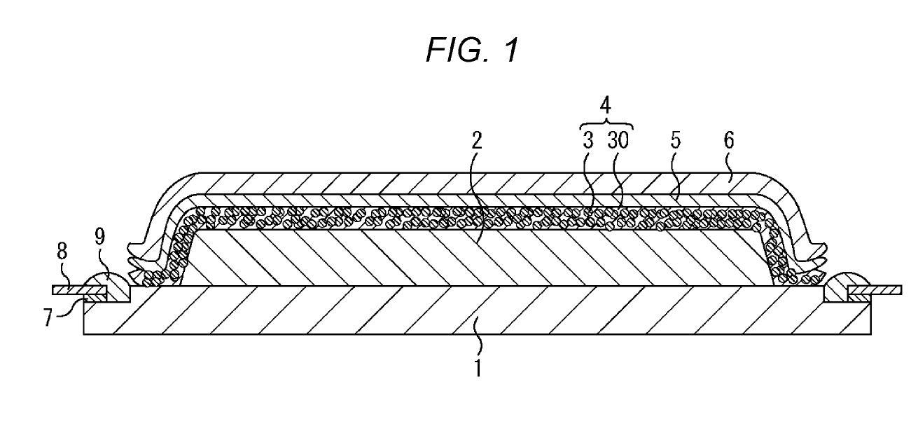

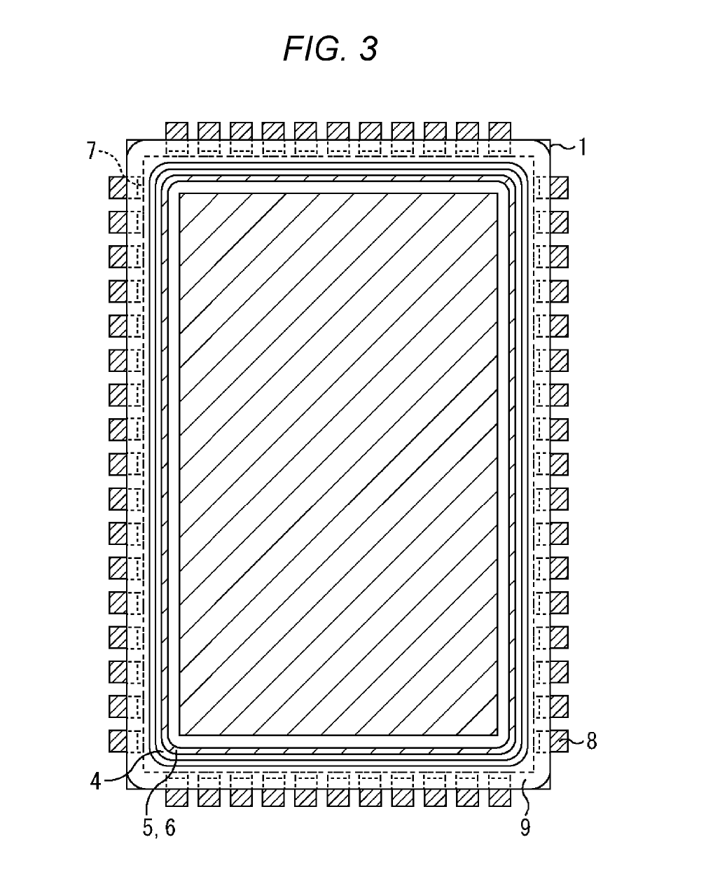

FIG. 1 is a schematic cross sectional view illustrating a structure of a radiation detecting apparatus according to a first embodiment, and FIG. 3 is a schematic plan view illustrating a structure of the radiation detecting apparatus of the first embodiment.

FIG. 1 illustrates a sensor panel 1, a scintillator layer 2, a light reflection layer 5, and a light reflection layer protective layer 6. A resin layer 4 sticks the scintillator layer 2 and the light reflection layer 5, and includes a resin 30 and a scintillator 3. A wiring member 8 that reads out a sensor output, a connecting portion 7, and a sealing member 9 are illustrated.

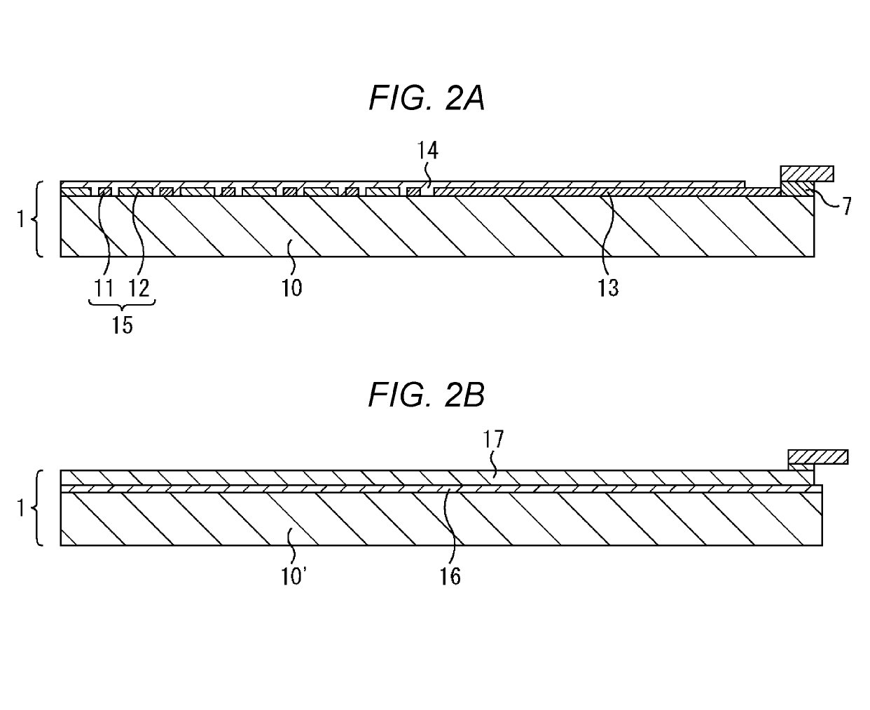

FIGS. 2A and 2B are schematic cross sectional views illustrating examples of the sensor panel of the radiation detecting apparatus according to the first embodiment. In FIG. 2A, the sensor panel 1 includes a substrate 10. On the substrate 10, a pixel 12 including a photoelectric conversion element and a switch element such as a TFT and a light-receiving portion 15 including a wiring 11 are formed. As the material for the substrate 10, glass, heat-resistant plastic, or the like is favorably used. The photoelectric conversion element 12 converts light converted from radiation by the scintillator layer 2 into an electric charge, and for example, amorphous silicon can be used. The configuration of the photoelectric conversion element 12 is not particularly limited, and a MIS sensor, a PIN sensor, a TFT sensor, or the like is appropriately used. A signal processing circuit and a TFT driving circuit are provided outside the sensor panel 1, and are connected through an electric connecting portion 13, the connecting portion 7, and the wiring member 8. A protective layer 14 covers and protects the light-receiving portion 15, and an inorganic film such as SiN and SiO₂ is favorably used.

In the present embodiment, a sensor panel of FIG. 2B is applicable other than the sensor panel on which a sensor is formed on the substrate 10 as illustrated in FIG. 2A. The sensor panel of FIG. 2B is formed such that a supporting substrate 10′ and a semiconductor substrate 17 provided with a photoelectric conversion element are stuck via an adhesive material 16, so that the sensor panel 1 is formed.

Referring back to FIG. 1, the columnar-structure scintillator layer 2 converts radiation into light having a detectable wavelength by a photoelectric conversion element, and it is favorable to use a scintillator having a columnar crystal structure. Note that, as the columnar-structure scintillator layer, a scintillator layer other than the scintillator layer having a columnar crystal structure may be used. For example, a scintillator layer in which the columnar structure is formed using a particulate scintillator may be used. As the material for the scintillator layer having a columnar crystal structure, a material having alkali halide as a main component is used. For example, CsI:Tl, CsI:Na, CsBr:Tl, or the like is used. As a manufacturing method thereof, a vapor deposition method is used. In a case of CsI, for example, the scintillator layer can be formed by directly depositing CsI and TlI on the sensor panel 1 at the same time.

The resin layer 4 is made of the resin 30 and the particulate scintillator 3. The resin layer 4 has a protective function against impact from an outside with respect to the scintillator layer 2. Further, the resin layer 4 may also have a moisture-proof function to prevent intrusion of moisture from outside air, and an adhesion function to stick the scintillator layer 2 and the light reflection layer 5. The thickness of the resin layer 4 is favorably about 20 to 200 μm. If the thickness is smaller than 20 μm, unevenness and a splash defect on the surface of the scintillator layer 2 cannot be thoroughly covered, and in a case of having the moisture-proof function, the moisture-proof function may be degraded. Further, in a case of having the adhesion function, the adhesion function is degraded, and pealing off may be caused between the scintillator layer 2 and the light reflection layer 5. Meanwhile, if the thickness is larger than 200 μm, scattering of light generated in the scintillator layer 2 or of light reflected at the light reflection layer 5 is increased in the resin layer 4, and resolution of an acquired image may be degraded. Therefore, by forming the resin layer 4 into about 20 to 200 μm in thickness, a sufficient moisture-proof function is exerted, and excellent image resolution can be obtained.

As the resin 30 used for the resin layer, it is favorable to use one having adhesion. To be specific, a polyimide, epoxy, polyolefin, polyester, polyurethane, or polyamide-based resin, or the like can be used, and, especially, a resin having low moisture permeability is desirable. Further, these resin materials can be used alone or as a mixture. Especially, as the resin 30, a hot melt resin may be used.

The hot melt resin does not include water and a solvent, and is a solid at a normal temperature, and is defined as an adhesion resin made of 100% non-volatile thermoplastic material. The hot melt resin is melted as the resin temperature rises, and is solidified as the resin temperature is decreased. Further, the hot melt resin has adhesion to other organic materials and inorganic materials in a heated and melted state, and becomes a solid-state at a normal temperature and does not have adhesion. Further, since the hot melt resin does not include a polarized solvent, a solvent, and water, the hot melt resin does not dissolve the scintillator even coming in contact with a deliquescent scintillator (for example, a scintillator layer made of alkali halide and having a columnar crystal structure), and thus can be used as a scintillator protective layer and a resin layer. The hot melt resin is different from a solvent volatilization curing-type adhesion resin that is formed such that a thermoplastic resin is dissolved in a solvent and is formed by a solvent application method. The hot melt resin is also different from a chemical reaction-type adhesion resin formed by a chemical reaction, represented by epoxy.

The resin layer 4 may be independently formed, or may be stuck with the light reflection layer 5 and the light reflection layer protective layer 6 in advance and formed into a sheet, and the sheet is stuck on the scintillator layer 2.

The particulate scintillator 3 is included in the resin layer 4. The material for the particulate scintillator 3 may not be similar to the scintillator material used for the scintillator layer 2. For example, it is favorable to use a material in which Gd₂O₂S is doped with Tb or the like, as particles. Alternatively, a particulate material similar to the material of the scintillator layer 2 may be used. As the amount of the scintillator 3 included in the resin layer 4, an amount that can sufficiently maintain the impact-absorbing function is favorable. In addition, an amount that can sufficiently maintain the adhesion function between the scintillator layer 2 and the light reflection layer 5, and the moisture-proof function of the resin layer 4 is favorable. To be specific, the volume density of about 1 to 70% is favorable. In addition, the particle diameter of the scintillator 3 is about 1 to 35 μm, and one having the film thickness smaller than that of the resin layer 4 is used.

As the method of forming the resin layer 4 including the particulate scintillator 3 and the resin 30, the resin 30 in which the particulate scintillator 3 is dispersed therein in advance may just be formed into a film by a coater, a roller, and the like, for example. Alternatively, the resin layer 4 can be formed such that the particulate scintillator 3 is arranged on the columnar-structure scintillator layer 2 or on the light reflection layer 5 in advance, and the resin 30 is applied thereon.

In this way, in the present embodiment, the particulate scintillator 3 is contained in the resin layer arranged between the columnar-structure scintillator layer 2 and the light reflection layer 5, and the particulate scintillator 3 emits light, so that the quantity of light that reaches the sensor panel 1 is improved.

The light reflection layer 5 reflects light that has proceeded into a side opposite to the sensor panel 1 among the light converted and emitted in the columnar-structure scintillator layer 2 and in the particulate scintillator 3, and leads the light to the sensor panel 1, thereby improving the efficiency for light utilization. As the light reflection layer 5, it is favorable to use a thin metal film having high reflectivity such as Al and Au, or a metal foil. Alternatively, it is favorable to use a plastic material having high reflectivity, or the like. The thickness is favorably about 1 to 100 μm. If the thickness is smaller than 1 μm, a pinhole defect is more likely to occur in forming the light reflection layer 5. If the thickness is larger than 100 μm, the absorbed amount of radiation is large and may be lead to an increase in radiation dose to which an object is exposed. Therefore, by forming the light reflection layer 5 into about 1 to 100 μm in thickness, the occurrence of a pinhole defect in forming the light reflection layer 5 can be suppressed, and the absorbed amount of radiation can be suppressed.

As the light reflection layer protective layer 6, a material that prevents destruction of the light reflection layer 5 due to impact and corrosion due to water is favorably used. As the material, a film material such as polyethylene-terephthalate, polycarbonate, vinyl chloride, polyethylene naphthalate, and polyimide is favorably used. The thickness of the light reflection layer protective layer 6 is favorably about 10 to 100 μm.

The connecting portion 7 is a member that electrically connects the electric connecting portion 13 and the wiring member 8, and is electrically connected with the wiring member 8 with an anisotropic conductive adhesive or the like. The wiring member 8 is a member for reading out an electrical signal converted in the photoelectric conversion element 2, and in which IC parts and the like are incorporated. So-called a tape carrier package (TCP) or the like is favorably used. The sealing member 9 has, with respect to the wiring member 8 and the electric connecting portion 13, a function to prevent corrosion due to water, a function to prevent destruction due to impact, and a function to prevent static electricity that occurs in manufacturing and might be a cause of destruction of the light-receiving portion 15.

A method of manufacturing a radiation detecting apparatus according to the present embodiment will be described with reference to FIG. 1 and FIGS. 2A and 2B. The method of manufacturing a radiation detecting apparatus includes the following processes S1 to S4.

In process S1, as illustrated in FIG. 1 and FIGS. 2A and 2B, the sensor panel 1 provided with the photoelectric conversion element 12 that detects entering light is prepared. In process S2, as illustrated in FIG. 1, the columnar-structure scintillator layer 2 is formed on the sensor panel 1. As the material for the columnar-structure scintillator layer 2, a material having alkali halide as a main component, such as CsI:Tl, CsI:Na, and CsBr:Tl can be used, for example. For example, in a case of CsI:Tl, the scintillator layer 2 is formed by directly depositing CsI and TlI on the sensor panel 1 at the same time by the vapor deposition method. However, the scintillator layer 2 may be formed such that CsI: Tl is deposed and is directly formed on the sensor panel 1 in process S2.

In process S3, the resin layer 4 including the particulate scintillator 3 is formed on the scintillator layer 2. The resin layer 4 includes the resin 30 and the particulate scintillator 3. In process S3, the resin layer 4 may be formed such that a hot melt including the particulate scintillator 3 is heated and stuck on the columnar-structure scintillator layer 2. Further, in process S3, the resin layer 4 including the particulate scintillator 3 may be formed such that the particulate scintillator 3 included in the resin layer 4 is arranged between columns of the columnar-structure scintillator 2. Further, in process S3, the resin layer 4 may be formed by sticking the resin layer 4 on the sensor panel 1 to cover the surface and side surfaces of the columnar-structure scintillator layer 2.

Processes S2 and S3 are in no particular order. That is, process S3 may be performed after process S2, or process S2 may be performed after process S3.

In process S4, the light reflection layer 5 is formed on the resin layer 4. As the light reflection layer 5, it is favorable to use a thin metal film having high reflectivity such as Al and Au, a metal foil, or a plastic material having high reflectivity, and is formed into about 1 to 100 μm in thickness.

In the radiation detecting apparatus according to the present embodiment, the particulate scintillator 3 mixed in the resin layer 4 emits light in addition to the columnar-structure scintillator layer 2. Therefore, the quantity of light as a whole is improved. As described above, according to the present embodiment, the quantity of light that reaches the sensor panel can be substantially improved by improving the quantity of light emission of the sensor panel as a whole even if the resin layer that sticks the scintillator layer and the light reflection layer is provided.

### Second Embodiment

In the present embodiment, a case of forming a resin layer 4 using a particulate scintillator 3 having smaller average columnar diameter than a columnar-structure scintillator layer 2 in process S3 of forming a resin layer including a particulate scintillator will be exemplarily illustrated. Here, the average columnar diameter of the columnar-structure scintillator layer 2 can be obtained by taking a SEM photograph from above the columnar-structure scintillator layer 2 to include 50 to 100 columnar structures, and performing calculation from the SEM photograph.

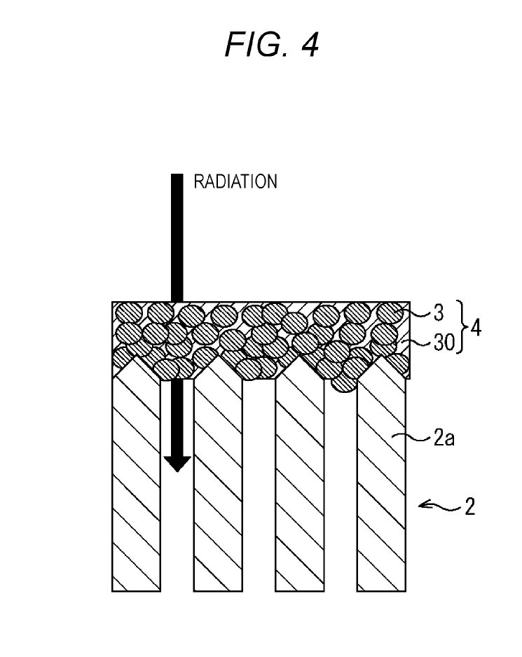

FIG. 4 is a schematic cross sectional view of an enlarged interface between the columnar-structure scintillator layer 2 and the resin layer 4 in a method of manufacturing a radiation detecting apparatus by a second embodiment. A small gap exists between adjacent columnar structures 2a of the columnar-structure scintillator layer 2. In the case of FIG. 4, the particle diameter of the particulate scintillator 3 included in the resin layer 4 is smaller than the columnar diameter of the columnar structure 2a. Therefore, the particulate scintillators 3 sufficiently exist in the resin layer 4 above the gap between the columnar structures 2a. Therefore, the radiation passing through the columnar structures 2a can be more efficiently used.

### Third Embodiment

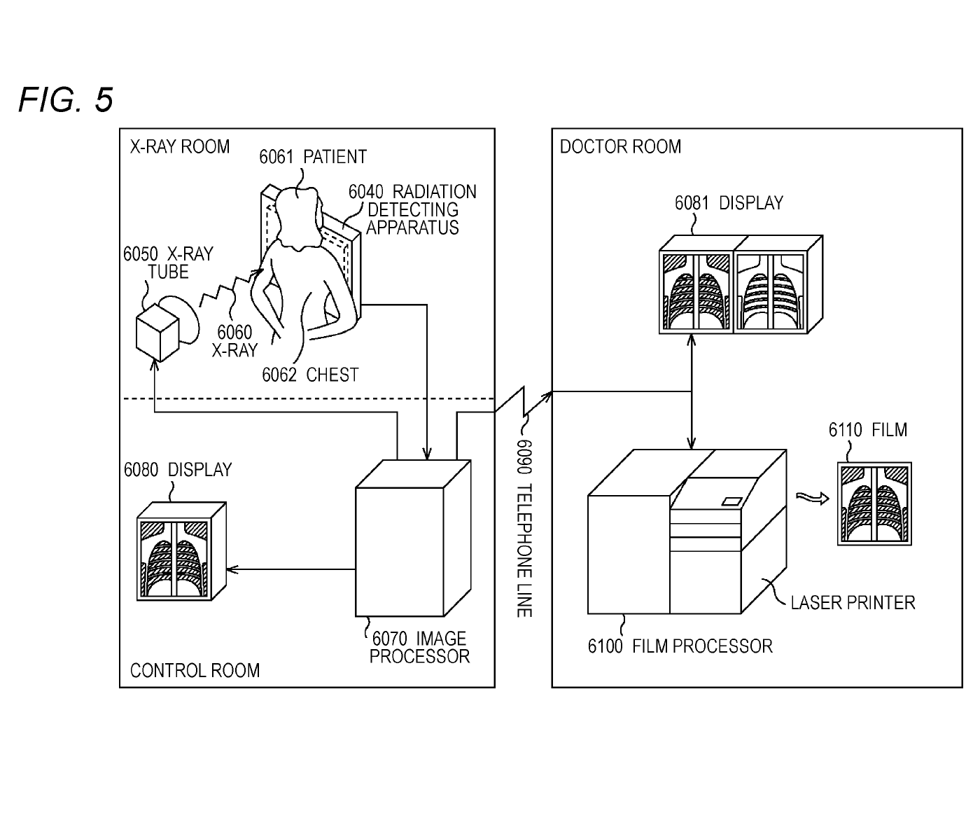

FIG. 5 is a schematic diagram illustrating an application example to a radiation detecting system (X-ray diagnostic system) provided with a radiation detecting apparatus according to the present invention.

In FIG. 5, an X-ray 6060 generated in an X-ray tube 6050 as a radiation source transmits a chest 6062 of a patient or an object 6061, and enters a radiation detecting apparatus (image sensor) 6040 illustrated in FIG. 1. This entering X-ray includes information of an interior part of the body of the patient 6061. At the image sensor 6040, the scintillator emits light in response to the entering of the X-ray, and a photoelectric conversion element of a sensor panel applies photoelectric conversion to the X-ray to obtain electric information. This information is converted into a digital signal and is subjected to image processing by an image processor 6070 as a signal processing unit, thereby can be observed with a display 6080 as a display unit of a control room.

In addition, this information can be transferred to a remote location by a transmission processing unit such as a network 6090 including a telephone, a LAN, and the Internet, and can be displayed on a display 6081 as a display unit of a doctor room at a separate place or can be stored in a recording unit such as an optical disk. A doctor at a remote location can give diagnosis. In addition, the information can be recoded on a film 6210 by a film processor 6100 as a recording unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-218072, filed Sep. 28, 2012, which is hereby incorporated by reference herein in its entirety.

What is claimed is:

1. A detecting apparatus comprising:
a sensor panel provided with a photoelectric conversion element configured to detect entering light;
a columnar-structure scintillator layer arranged on the sensor panel;
a light reflection layer arranged on the columnar-structure scintillator layer; and
a resin layer arranged between the columnar-structure scintillator layer and the light reflection layer,
wherein the resin layer includes a particulate scintillator.

2. The detecting apparatus according to claim 1, wherein
the particulate scintillator is smaller than an average columnar diameter of the columnar-structure scintillator layer.

3. A radiation detecting system comprising:
the detecting apparatus according to claim 1;
a signal processing unit configured to process a signal from the detecting apparatus;
a recording unit configured to record a signal from the signal processing unit;
a display unit configured to display a signal from the signal processing unit; and
a transmission processing unit configured to transmit a signal from the signal processing unit.

4. The radiation detecting system according to claim 3, further comprising:
a radiation source configured to generate radiation.

5. A method of manufacturing a detecting apparatus, comprising:
preparing a sensor panel provided with a photoelectric conversion element configured to detect entering light;
forming a columnar-structure scintillator layer on the sensor panel;
forming a resin layer including a particulate scintillator on the columnar-structure scintillator layer, and
forming a light reflection layer on the resin layer.

6. The method of manufacturing a detecting apparatus according to claim 5, wherein the forming of the resin layer including the particulate scintillator is a process of heating a hot melt including the particulate scintillator and sticking and forming the heated hot melt on the columnar-structure scintillator layer.

7. The method of manufacturing a detecting apparatus according to claim 5, wherein
in the forming of the resin layer including the particulate scintillator, the particulate scintillator included in the resin layer is arranged between columnar-structure scintillators of the columnar-structure scintillator layer.

8. The method of manufacturing a detecting apparatus according to claim 5, wherein
in the forming of the resin layer including the particulate scintillator, the particulate scintillator smaller than an average columnar diameter of the columnar-structure scintillator layer is used.

9. The method of manufacturing a detecting apparatus according to claim 5, wherein
in the forming of the resin layer including the particulate scintillator, the resin layer is stuck on the sensor panel to cover a surface and side surfaces of the columnar-structure scintillator layer.

10. The method of manufacturing a detecting apparatus according to claim 5, wherein
in the forming of the columnar-structure scintillator layer, the columnar-structure scintillator layer made of CsI is directly formed on the sensor panel by a vapor deposition method.
